(19) United States
(12) Patent Application Publication
(10) Pub. No.: US 2023/0154273 A1
(43) Pub. Date: May 18, 2023

(54) GAMING MACHINE AND METHOD WITH SYMBOL REDISTRIBUTION FEATURE

(71) Applicant: SG Gaming, Inc., Las Vegas, NV (US)

(72) Inventors: George BOUVIER, Henderson, NV (US); Richard MILOSEVICH, Las Vegas, NV (US); John R. VALLEJO, Henderson, NV (US)

(21) Appl. No.: 17/529,661

(22) Filed: Nov. 18, 2021

(51) Int. Cl. G07F 17/32; G07F 17/34

(52) U.S. Cl. CPC G07F 17/3213; G07F 17/3267; G07F 17/3251; G07F 17/34

(57) ABSTRACT

There is provided a gaming system, gaming machine, and method that utilize an electronic display device configured to display a plurality of symbol-bearing reels and a base game array. The base game array has a first configuration. The reels are spun and stopped to populate the base game array with symbols from the stopped reels. In response to the symbols including a combination of bonus-triggering symbols, the display device is configured to display a bonus game array having a second configuration different than the first configuration. The bonus-triggering symbols are randomly redistributed from the base game array to the bonus game array for use in a bonus game.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2021, SG Gaming, Inc.

### FIELD OF THE INVENTION

The present invention relates to a technological improvement to gaming systems, gaming machines, and methods and, more particularly, to new and improved animations in connection with a symbol redistribution feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

According to an embodiment of the present invention, there is provided a gaming system, gaming machine, and method that utilize an electronic display device configured to display a plurality of symbol-bearing reels and a base game array. The base game array has a first configuration. The reels are spun and stopped to populate the base game array with symbols from the stopped reels. In response to the symbols including a combination of bonus-triggering symbols, the display device is configured to display a bonus game array having a second configuration different than the first configuration. For example, the base game array may include one or more symbol positions that do not correspond to any symbol positions in the bonus game array. The bonus-triggering symbols are randomly redistributed from the base game array to the bonus game array for use in a bonus game.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is a flowchart for a data processing method that corresponds to instructions executed by a controller, according to an embodiment of the present invention.

FIGS. 4A-4B and 5A-5B depict exemplary representations of base and bonus game images that illustrate aspects of the data processing method. FIGS. 4A and 4B are respective base and bonus game images associated with a first wagering game cycle, while FIGS. 5A and 5B are respective base and bonus game images associated with a second, different wagering game cycle.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

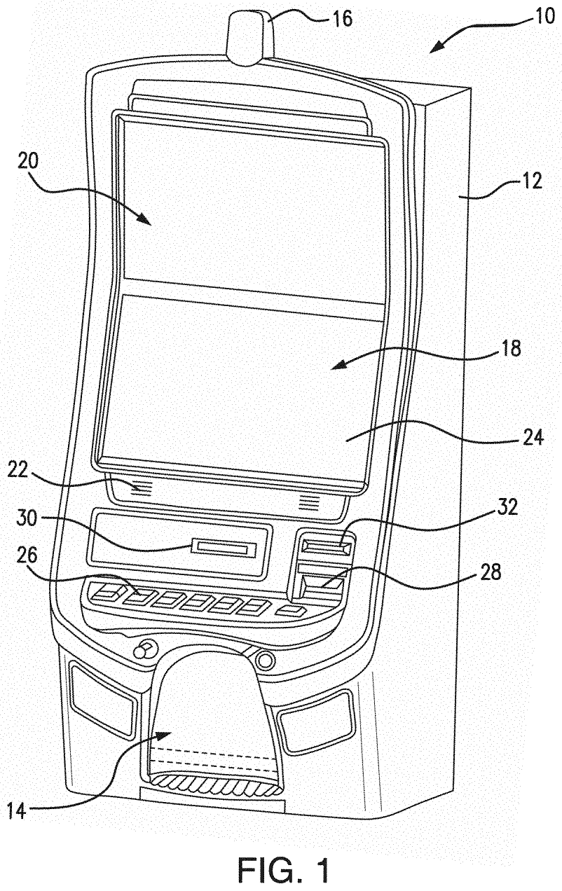

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 24 mounted over the primary or secondary displays, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

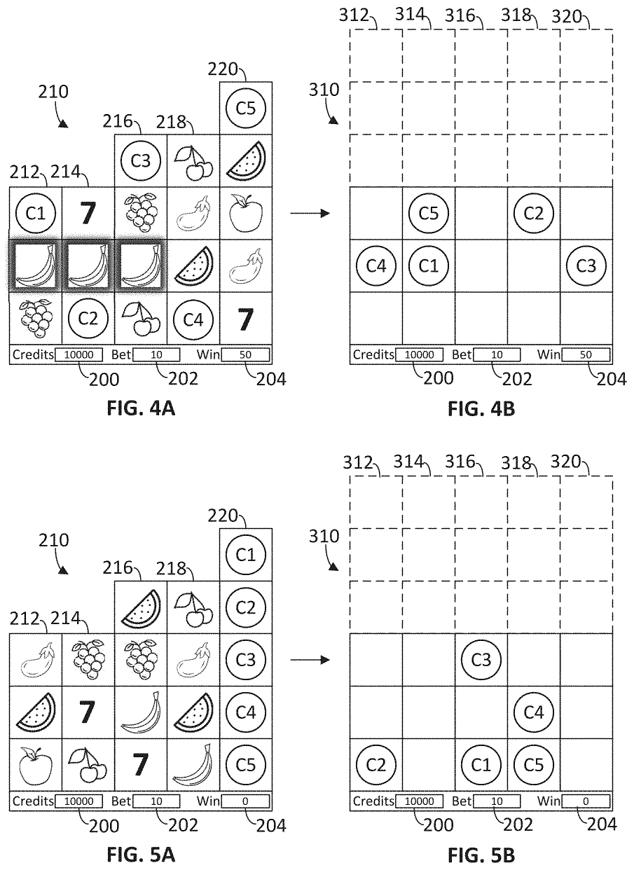

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIG. 4). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 200 (see FIG. 4), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

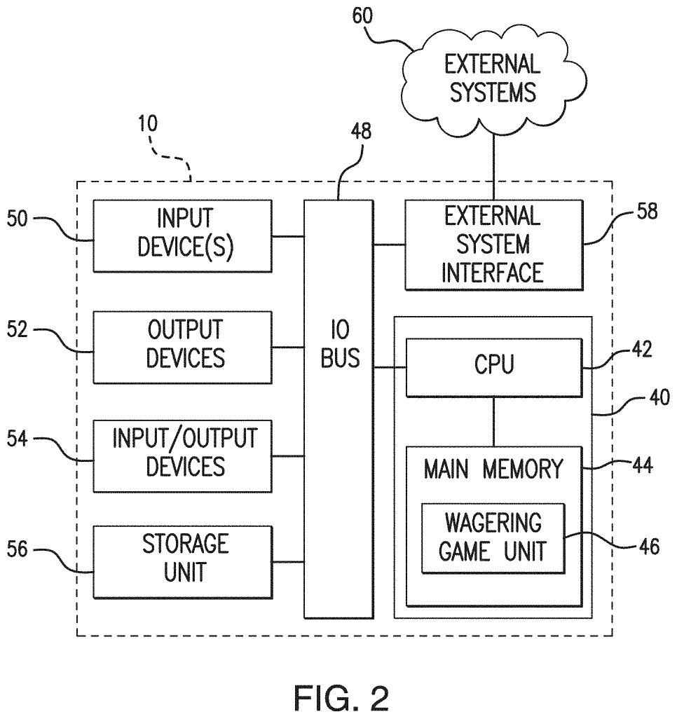

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

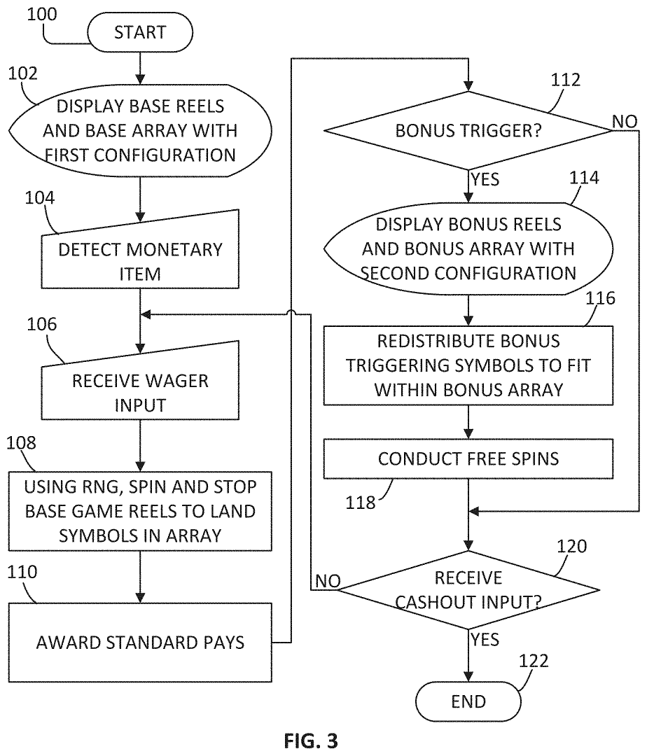

Referring now to FIG. 3, there is shown a flowchart representing one data processing method corresponding to at least some instructions stored and executed by the game-logic circuitry 40 in FIG. 2 to perform operations according to an embodiment of the present invention. The data processing method is described below in connection with the exemplary representations of game images in FIGS. 4A-4B and 5A-5B.

The data processing method commences at step 100. At step 102, the game-logic circuitry directs an electronic display device (e.g., video display) of the gaming machine to display a plurality of symbol-bearing reels and an array of symbol positions for a base game portion of a casino wagering game. The symbol positions of the base game array are arranged in a first configuration, format, or structure and comprise a plurality of rows and columns. The rows of the array are oriented in a horizontal direction, and the columns of the array are oriented in a generally vertical direction. Alternatively, the “rows” of the array may be oriented in a vertical direction, and the “columns” of the array may be oriented in a horizontal direction. The symbol positions in each row of the array are horizontally aligned with each other, and the symbol positions in each column of the array are vertically aligned with each other. The number of symbol positions in different rows and/or different columns may vary from each other. The reels may be associated with the respective columns of the array such that the reels spin vertically and each reel populates a respective column. The reel spin is animated by depicting symbol-bearing strips moving vertically across the display and synchronously updating the symbols visible on each strip as the strip moves across the display. In another embodiment, the reels may be associated with the respective rows of the array such that the reels spin horizontally and each reel populates a respective row. In yet another embodiment, the reels may be associated with respective individual symbol positions of the array such that each reel populates only its respective symbol position. In the examples shown in FIGS. 4A and 5A, the electronic display device displays a stepped base game array 210 including five columns 212, 214, 216, 218, 220 arranged from left to right. Columns 212 and 214 each include three symbol positions, columns 216 and 218 each include four symbol positions, and column 220 includes five symbol positions.

At step 104, the game-logic circuitry detects, via at least one of one or more electronic input devices, a physical item associated with a monetary value that establishes a credit balance. As shown in FIG. 4A, for example, the credit balance may be shown on a credit meter 200 of the gaming machine.

At step 106, the game-logic circuitry initiates a wagering game cycle in response to an input indicative of a wager covered by the credit balance. To initiate a spin of the reels, the player may press a “Spin” or “Max Bet” key on a button panel or touch screen. As shown in FIG. 4A, for example, the wagered amount may be shown on a bet meter 202 of the gaming machine.

At step 108, using an RNG, the game-logic circuitry spins and stops the base game reels to randomly land symbols from the reels in the base game array in visual association with one or more paylines (also known as lines, ways, patterns, or arrangements). The game-logic circuitry is configured to evaluate the displayed array of symbols and provides immediate awards and bonus games in accordance with a pay table. The pay table may, for example, include “line pays” and “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Each payline preferably consists of a single symbol position in each column of the array. The number of paylines may be as few as one or as many as possible given each payline consists of a single symbol position in each column of the array. FIGS. 4A and 5A depict exemplary representations of the base game array in different wagering game cycles after the base game reels have been spun and stopped to randomly populate the array 210 with symbols from the reels.

At step 110, the game-logic circuitry awards payouts for any standard pays (e.g., line pays and scatter pays) as determined by the game's pay table. As shown in FIG. 4A, for example, the spin of the base game reels generated a line pay of three BANANA symbols worth 50 credits. The awarded payouts are added to a win meter 204 of the gaming machine.

At step 112, the game-logic circuitry determines whether or not a bonus game has been triggered. In one embodiment, the bonus game is triggered by at least five COIN symbols appearing anywhere in the base game array (i.e., “scatter trigger”). In another embodiment, the bonus game is triggered by filling any of the columns of the base game array with COIN symbols. In yet another embodiment, the bonus game is triggered by filling any of the rows of the base game array with COIN symbols. In a further embodiment, the bonus game is triggered by at least five COIN symbols appearing along an active payline (i.e., “line trigger”). When a COIN symbol lands in the base game array as a result of a spin of the base game reels, the COIN symbol may be held or locked in its landing position for one or more additional spins/plays of the base game. The locked COIN symbol may be unlocked and removed from the base game array in response to a triggering event, such as the failure to land an additional COIN symbol in the base game array in a subsequent spin or a subsequent set (e.g., three) of spins, the failure to land an additional COIN symbol in the same column as the locked COIN symbol in a subsequent spin or a subsequent set (e.g., three) of spins, or the failure to land an additional COIN symbol in the same row as the locked COIN symbol in a subsequent spin or a subsequent set (e.g., three) of spins.

By way of example, if the bonus game is triggered by at least five COIN symbols appearing anywhere in the base game array, FIG. 4A depicts that the bonus game is triggered by five COIN symbols C1, C2, C3, C4, and C5 in respective columns 212, 214, 216, 218, and 220. And FIG. 5A depicts that the bonus game is triggered by five COIN symbols C1, C2, C3, C4, and C5 filling column 220.

If the bonus game is not triggered at step 112, the data processing method immediately proceeds to step 120.

If, however, the bonus game is triggered at step 112, the data processing method proceeds to steps 114, 116, and 118. At step 114, the game-logic circuitry directs the electronic display device (e.g., video display) of the gaming machine to display a plurality of symbol-bearing reels and an array of symbol positions for a bonus game portion of a casino wagering game. The symbol positions of the bonus game array are arranged in a second configuration, format, or structure and comprise a plurality of rows and columns. The second configuration of the bonus game array is preferably different than the first configuration of the base game array. The number of symbol positions in the base game array may be greater than the initial number of symbol positions in the base game array. The number of rows in the base game array may be greater than the initial number of rows in the bonus game array. The base game array may include one or more symbol positions that are not included in (do not correspond to or do not fit within) the bonus game array.

As described above in connection with the base game array, the rows of the bonus game array are oriented in a horizontal direction, and the columns of the bonus game array are oriented in a generally vertical direction. Alternatively, the “rows” of the array may be oriented in a vertical direction, and the “columns” of the array may be oriented in a horizontal direction. The symbol positions in each row of the array are horizontally aligned with each other, and the symbol positions in each column of the array are vertically aligned with each other. The number of symbol positions in different rows and/or different columns may vary from each other. The bonus game reels may be associated with the respective columns of the array such that the reels spin vertically and each reel populates a respective column. The reel spin is animated by depicting symbol-bearing strips moving vertically across the display and synchronously updating the symbols visible on each strip as the strip moves across the display. In another embodiment, the reels may be associated with the respective rows of the array such that the reels spin horizontally and each reel populates a respective row. In yet another embodiment, the reels may be associated with respective individual symbol positions of the array such that each reel populates only its respective symbol position. In the examples shown in FIGS. 4B and 5B, the electronic display device displays a rectangular bonus game array 310 including five columns 312, 314, 316, 318, 320 arranged from left to right. Each column includes three symbol positions.

At step 116, because of the different configurations of the base and bonus game arrays, the game-logic circuitry directs the electronic display device to randomly redistribute the bonus-triggering symbols, i.e., the COIN symbols, from the base game array to fit within the bonus game array. The redistribution of COIN symbols may be shown by animating reconfiguration of the array from the base game configuration to the bonus game configuration and animating movement of the COIN symbols from their positions in the base game array to their redistributed positions in the bonus game array. In one embodiment, all COIN symbols in the base game array are randomly redistributed within the bonus game array. In another embodiment, to the extent the base and bonus game arrays have corresponding symbol positions, COIN symbols in those positions remain in place when carried over from the base game array to the bonus game array; whereas the remaining COIN symbols in base-array symbol positions (that do not have corresponding bonus-array symbol positions) are randomly redistributed within the bonus game array. In a further embodiment, instead of randomly redistributing the bonus-triggering symbols, the symbol positions of the base game array may be mapped to respective symbol positions of the bonus game array. The bonus-triggering symbols are redistributed from their base-game symbol positions to the bonus-game symbol positions associated therewith by such mapping.

FIGS. 4B and 5B depict exemplary representations of the bonus game array 310 in different wagering game cycles in which the bonus-triggering COIN symbols are randomly redistributed from the base game arrays 210 in FIGS. 4A and 4B to fit within the respective bonus game arrays 310 in FIGS. 4B and 5B. More specifically, in FIG. 4A COIN symbols C1, C2, C3, C4, and C5 in the base game array 210 are redistributed within the bonus game array 310 in FIG. 4B. In an alternative embodiment, COIN symbols C1, C2, and C4 remain in place (carry over to corresponding positions in the bonus game array 310), whereas COIN symbols C3 and C5 (which do not have corresponding positions in the bonus game array 310) are randomly redistributed within the bonus game array 310. In FIG. 5A COIN symbols C1, C2, C3, C4, and C5 in the base game array 210 are redistributed within the bonus game array 310 in FIG. 5B. In an alternative embodiment, COIN symbols C3, C4, and C5 remain in place (carry over to corresponding positions in the bonus game array 310), whereas COIN symbols C1 and C2 (which do not have corresponding positions in the bonus game array 310) are randomly redistributed within the bonus game array 310.

At step 118, the game-logic circuitry conducts the bonus game with the redistributed bonus-triggering COIN symbols. The bonus game may, for example, involve a series of free spins of bonus game reels. In each free spin, the COIN symbols may be held or locked in place as the bonus game reels populate other symbol positions in the bonus game array. If additional COIN symbols land in the bonus game array, the additional COIN symbols may likewise be held or locked in place. As more COIN symbols are collected over the course of the free spins, the bonus game array 310 may expand and activate additional rows shown in dotted lines in FIGS. 4B and 5B. At the conclusion of the bonus game, the game-logic circuitry may award the values borne by all COIN symbols that landed in the bonus game array and then proceeds to step 120. Such a bonus game is disclosed in U.S. Pat. No. 10,643,431 to Chesworth et al., which is incorporated herein by reference in its entirety.

At step 120, the game-logic circuitry determines whether or not it has received a cashout input via at least one of the one or more player input devices of the gaming machine. If it has not received a cashout input, the game-logic circuitry waits for the next wager input at step 106. If it has received a cashout input, the game-logic circuitry initiates a payout from the credit balance on the credit meter such as the meter 200 in FIG. 4A. The data processing method then ends at step 122.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

1. A method of operating a gaming machine comprising game-logic circuitry, the method comprising the operations of:
under control of the game-logic circuitry:
displaying, on an electronic display device, a plurality of symbol-bearing reels and a base game array, the base game array having a first configuration; and
spinning and stopping the plurality of symbol-bearing reels to populate the base game array with symbols from the stopped reels; and
in response to the symbols including a combination of bonus-triggering symbols:
displaying, on the electronic display device, a bonus game array having a second configuration, the second configuration being different than the first, wherein the base game array includes one or more symbol positions that do not correspond to any symbol positions in the bonus game array, and wherein the displaying of the bonus game array comprises animating reconfiguration of the array from first configuration to the second configuration; and
redistributing one or more of the bonus-triggering symbols from the base game array to the bonus game array for use in a bonus game, wherein the redistributing operation includes randomly redistributing only those bonus-triggering symbols located in the one or more symbol positions that do not correspond to any symbol positions in the bonus game array, wherein any other ones of the bonus-triggering symbols are carried over from their symbol positions in the base game array to corresponding positions in the bonus game array, and wherein the redistributing operation comprises animating movement of the bonus-triggering symbols from their positions in the base game array to their positions in the bonus game array.

2. The method of claim 1, further including spinning and stopping a second plurality of symbol-bearing reels to populate the bonus game array with additional symbols besides the bonus-triggering symbols.

3. The method of claim 1, wherein the bonus-triggering symbols are value-bearing symbols bearing respective values.

4. (canceled)

5. The method of claim 4, wherein a number of symbol positions in the base game array is greater than an initial number of symbol positions in the bonus game array.

6. The method of claim 4, wherein a number of rows in the base game array is greater than an initial number of rows in the bonus game array.

7. The method of claim 4, wherein the redistributing operation includes randomly redistributing the one or more of the bonus-triggering symbols.

8. (canceled)

9. The method of claim 1, wherein the first configuration is stepped such that a number of symbol positions in different columns of the base game array varies from each other, and the second configuration is rectangular such that a number of symbol positions in different columns of the bonus game array is the same.

10. The method of claim 1, further comprising:
detecting, via at least one of one or more electronic input devices, a physical item associated with a monetary value that establishes a credit balance; and
receiving, via at least one of the one or more electronic input devices, a cashout input that initiates a payout from the credit balance.

11. A gaming system comprising:
a gaming machine including an electronic display device configured to display a plurality of symbol-bearing reels and a base game array, the base game array having a first configuration; and
game-logic circuitry configured to perform the operations of:
spinning and stopping the plurality of symbol-bearing reels to populate the base game array with symbols from the stopped reels; and
in response to the symbols including a combination of bonus-triggering symbols:
directing the electronic display device to display a bonus game array having a second configuration, the second configuration being different than the first configuration, wherein the base game array includes one or more symbol positions that do not correspond to any symbol positions in the bonus game array, and wherein the displaying of the bonus game array comprises animating reconfiguration of the array from first configuration to the second configuration; and
redistributing one or more of the bonus-triggering symbols from the base game array to the bonus game array for use in a bonus game, wherein the redistributing operation includes randomly redistributing only those bonus-triggering symbols located in the one or more symbol positions that do not correspond to any symbol positions in the bonus game array, wherein any other ones of the bonus-triggering symbols are carried over from their symbol positions in the base game array to corresponding positions in the bonus game array, and wherein the redistributing operation comprises animating movement of the bonus-triggering symbols from their positions in the base game array to their positions in the bonus game array.

12. The gaming system of claim 11, wherein the game-logic circuitry is configured to perform the operation of spinning and stopping a second plurality of symbol-bearing reels to populate the bonus game array with additional symbols besides the bonus-triggering symbols.

13. The gaming system of claim 11, wherein the bonus-triggering symbols are value-bearing symbols bearing respective values.

14. (canceled)

15. The gaming system of claim 14, wherein a number of symbol positions in the base game array is greater than an initial number of symbol positions in the bonus game array.

16. The gaming system of claim 14, wherein a number of rows in the base game array is greater than an initial number of rows in the bonus game array.

17. The gaming system of claim 14, wherein the redistributing operation includes randomly redistributing the one or more of the bonus-triggering symbols.

18. (canceled)

19. The gaming system of claim 11, wherein the first configuration is stepped such that a number of symbol positions in different columns of the base game array varies from each other, and the second configuration is rectangular such that a number of symbol positions in different columns of the bonus game array is the same.

20. The gaming system of claim 11, wherein the game-logic circuitry is configured to perform the operations of:
detecting, via at least one of one or more electronic input devices, a physical item associated with a monetary value that establishes a credit balance; and
receiving, via at least one of the one or more electronic input devices, a cashout input that initiates a payout from the credit balance.
